(19) United States
(12) Patent Application Publication
(10) Pub. No.: US 2004/0098295 A1
(43) Pub. Date: May 20, 2004

(54) Method and system for scheduling workload

(75) Inventors: John David Sarlay, Dallas, TX (US); Paul Harold Leamon, McKinney, TX (US); Meghan Barni, Mahopac, NY (US)

Correspondence Address: CARR LAW FIRM, L.L.P., 670 FOUNDERS SQUARE, 900 JACKSON STREET, DALLAS, TX, 75202, US

(73) Assignee: IEX Corporation, Richardson, TX (US)

(21) Appl. No.: 10/714,017

(22) Filed: Nov. 14, 2003

Related U.S. Application Data
(60) Provisional application No. 60/426,555, filed on Nov. 15, 2002.

(51) Int. Cl. G06F 17/60

(52) U.S. Cl. 705/8

(57) ABSTRACT

The present invention provides for rescheduling workload. A period is selected. A contacts forecasted to be received (CRF) value for the selected period is selected. A contacts forecasted to be handled (CHF) value for the selected period is selected. A volume of contacts that can be handled based on agent schedules (CHS) is calculated. A contacts handled intraday value (CHI) is determined based on these values, possibly also using values for contacts actually received and handled and perhaps using backlog values and/or backlog threshold values. The CHI value is then overwritten as a function of the CHI value of a previous period, the contacts actually handled (CHA) value of a previous period, and other metrics of contact processing.

PRIORITY

This Application claims priority from a provisional application filed Nov. 15, 2002, entitled “Method and Apparatus for Managing Intraday Contacts”, serial No. 60/426,555 which is hereby incorporated by reference for all purposes.

### TECHNICAL FIELD

The invention relates generally to a workforce management system and, more particularly, to rescheduling work over different periods of time, such as responding to multimedia contacts.

### BACKGROUND

A call center comprises an organization of people, telecommunications equipment and management software, with the mission of efficiently handling telephone-based customer contacts. A typical call center balances competing goals. Customers should experience high quality and consistent service as measured, for example, by how long the customer's call must wait in queue before being answered, generally measured in terms of seconds or minutes. At the same time, this service should be provided at the lowest possible cost to the call center owner.

Workforce management systems provide important tools for meeting the goals of the call center. These systems generate forecasts of call received volumes and call handling times based on historical data to determine how much staff will be needed at different times of the day and week. The systems then create schedules that match the staffing to the anticipated needs.

As methods of communications expand, however, call centers are also expected to handle various forms of multimedia contacts, such as mail, e-mails, faxes, web chats, voice mails, video calls and the like. Typically, these other types of multimedia contacts allow a slower response time than calls, such as minutes, hours, days, and the like. A call center expected to handle voice calls and multimedia contacts is generally referred to as a contact center.

However, there can be problems in the contact center environment. For instance, the forecasting of contacts, even an updated forecasting, of how many contacts can be handled for any one contact period may not be 100% accurate. For instance, agents might call in sick, the contact center might receive more or less phone calls than estimated, in an initial forecast of contacts to be handled during a given period.

This can create problems when actually trying to implement a forecasted handling plan on a day to day level. In other words, implementing an intra-day forecasted handling plan (that is, how the forecasted contacts that are to be handled by agents are changed during the day) can be difficult, due to variations between the predicted outcome and reality.

Furthermore, backlog management can be an issue in a multimedia or contact center environment. For instance, because there can be variations between the predicted number and type of contacts to be handled, and the contacts actually received and handled, it is possible to have problems with the corresponding backlog of these contacts. For instance, if the forecasted contacts are less than the actual contacts for a certain time period by a given amount, the backlog will increase, perhaps to the point where it will be too difficult or even impossible for agents to catch up. However, if the actual contacts handled exceed the forecasted contacts for a given time period by more than a certain amount, there could be a time when agents are not processing contacts. This means that workers are being paid without being productive, which is also generally unacceptable.

Therefore, a need exists for a method and a system that compensates for variations between the forecasted contacts to be received, the actual contacts received, the forecasted contacts to be handled, the actual contacts handled, and the number of contacts that should be able to be handled by the scheduled staff that addresses at least some of the problems associated with conventional multimedia center technology.

### SUMMARY

The present invention provides for rescheduling workload. A period is selected. A contacts forecasted to be received (CRF) value for the selected period is selected. A contacts forecasted to be handled (CHF) value for the selected period is selected. A contacts handled intraday value (CHI) is generated as at least a function of CHF value. At least part of one or more steps above are performed on at least one processing device.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically depicts a network environment in which multimedia contacts are managed;

FIG. 2 is a flow diagram illustrating initiating deriving an initial Contacts Handled Intraday (CHI) and a contacts received intraday (CRI) value;

FIG. 3 is a flow diagram illustrating overwriting the contacts handled intraday (CHI) value for a current period;

FIG. 4 is a flow diagram illustrating a step of obtaining a CHI value when the number of contacts actually handled (CHA) in a previous period is available;

FIG. 5 is a low-level flow diagram illustrating a step of obtaining a CHI value when the number of contacts actually handled (CHA) in a previous period is not available;

FIG. 6 is a line chart illustrating historical backlog data;

FIG. 7 is a line chart illustrating an expired backlog prediction using historical expired and unexpired backlog data;

FIG. 8 is a line chart illustrating a future trend of a total backlog;

FIG. 9 illustrates a method for updating the CHI value as a function of a backlog;

FIGS. 10A and 10B illustrate an example of a propagation of contacts before real-time data (CHA or CRA) has been received; and

FIGS. 11A and 11B illustrate an example of a propagation of contacts after real-time data has been received (CHA or CRA).

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning automatic call distributors, multimedia servers, and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor such as a computer or electronic data processor in accordance with code such as computer program code, software, or integrated circuits that are coded to perform such functions.

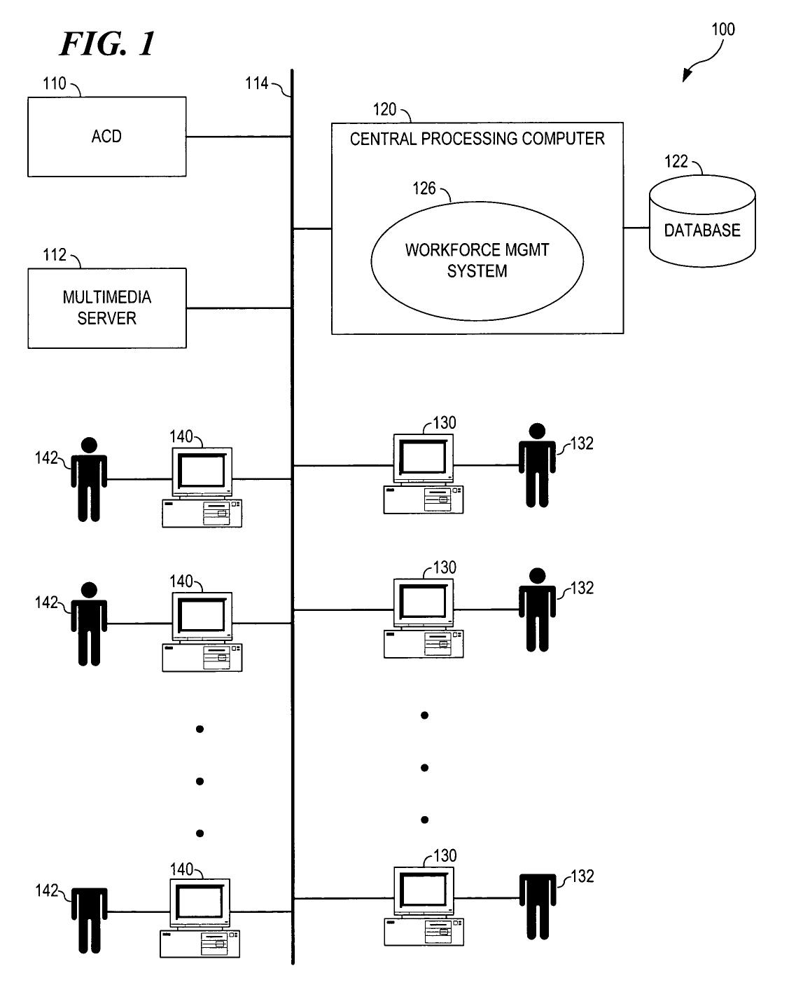

It is still further noted that, while the description of the invention is made in reference to a single contact center, the methods and systems described herein may also be incorporated for and/or across multiple contact centers. The principles of the present invention and their advantages are best understood by referring to the FIGS. 1-11B.

Referring to FIG. 1 of the drawings, the reference numeral 100 generally designates one environment that embodies features of the present invention. The environment 100 is exemplified herein as a contact center environment, though it is understood that other types of environments may constitute the environment 100 as well, and that the environment 100 is not limited to being a contact center environment and may, for example, include environments such as sales force environments, field service environments, manufacturing environments and other types of environments in which tasks must be finished within a certain amount of time.

The environment 100 generally comprises an automatic call distributor (ACD) 110 and a multimedia server 112 coupled to a central processing computer 120 via a network 114, such as a wireline and/or wireless local area network (LAN), a wireline and/or wireless wide area network (WAN), the Internet, an Intranet, or the like. The ACD 110 and multimedia server 112 generally provide routing capabilities for incoming voice calls (via the ACD) and other contacts (via the multimedia server), such as faxes, e-mails, voice mails, web requests, web callback requests, web chats, web voice calls, web video calls, and the like. The function and operation of the ACD 110 and multimedia server 112 are considered to be well known to a person having ordinary skill in the art and, therefore, will not be discussed in further detail herein, except to the extent necessary to disclose the present invention.

The central processing computer 120 receives from the ACD 110 and the multimedia server 112 periodic contact information, such as the number of contacts received and handled for each contact type (“CT”) (i.e., a CT is the type of contact, such as voice call, e-mail, fax, voice mail, web requests, web call-back requests, web chats, web voice calls, web video calls, and the like), the average handling time (“AHT”) of each CT, and the like, and is preferably stored in database 122. Furthermore, there can be multiple CTs for a multimedia server 112. For instance, there can be a CT for Sales E-mail and another for Service E-mail. Furthermore, the system 100 can sort e-mails or other contact types by importance. For instance, an e-mail CT from one customer can be required to be responded to in 3 hours, but an e-mail CT from a second customer can be required to be responded to in 30 minutes.

While the database 122 is shown external to the computer, one skilled in the art will appreciate that the database 122 may be included within the central processing computer 120, or that the data may be retrieved from the ACD 110 and/or the MM server 112, or some other source, when needed instead of storing the data in the database 122. These variations, and others, are considered to be well known to one skilled in the art upon a reading of the present disclosure.

The central processing computer 120 is also coupled via the network 114 to one or more agent workstations 130 and to one or more supervisor workstations 140, which provide an interface between the network 114 and one or more agents 132 and supervisors 142, respectively. The agent workstations 130 and the supervisor workstations 140 are preferably configured to access the central processing computer 120 via the network 114.

Agents 132 access, via telephones (not shown) and agent workstations 130, the ACD 110, multimedia server 112, or other contact servers (not shown) to aid in contact resolution. As the agents 132 service the contacts, the ACD 110 and the multimedia server 112 collect data pertaining to the contacts received and contacts handled and periodically transmit the data to the central processing computer 120, which preferably stores the information in the database 122.

In one embodiment of the present invention, the central processing computer 120 comprises a workforce management system (WMS) 126, such as the TotalView® Workforce Management system available from IEX Corporation. The WMS 126 integrates many management functions, such as workforce forecasting and scheduling, skill planning and scheduling, multimedia contact management, real-time schedule adherence, and the like, and provides an interface to the database 122. Additionally, the WMS 126 generates forecasts of call volumes and call handling times based on historical data, and determines how much staff will be needed at different times of the day and week. Furthermore, these systems have the capability of creating schedules that match the staffing to the anticipated needs. A representative system is described in U.S. Pat. No. 5,325,292, which patent is assigned to the assignee of this application and is incorporated herein by reference for all purposes. The WMS 126 can provide multimedia contact forecasting, planning, and scheduling capabilities. Alternatively, however, a method and/or an apparatus implementing features of the present invention may be designed as a stand-alone component or feature.

In the system 100, the WMS 126 generates initial predictions of the contacts that should be handled by agents (CHF). Generally, CHF represents an initial estimation of the number of contacts that should be handled by agents in the ACD 110. From the CHF value, and other values, such as the number of contacts actually handled (CHA) for a previous time period or periods, the WMS 126 generates a contacts handled intraday value (CHI). Generally, the CHI value can be defined as an updated forecast of the number of contacts that should be handled by agents during a given time period.

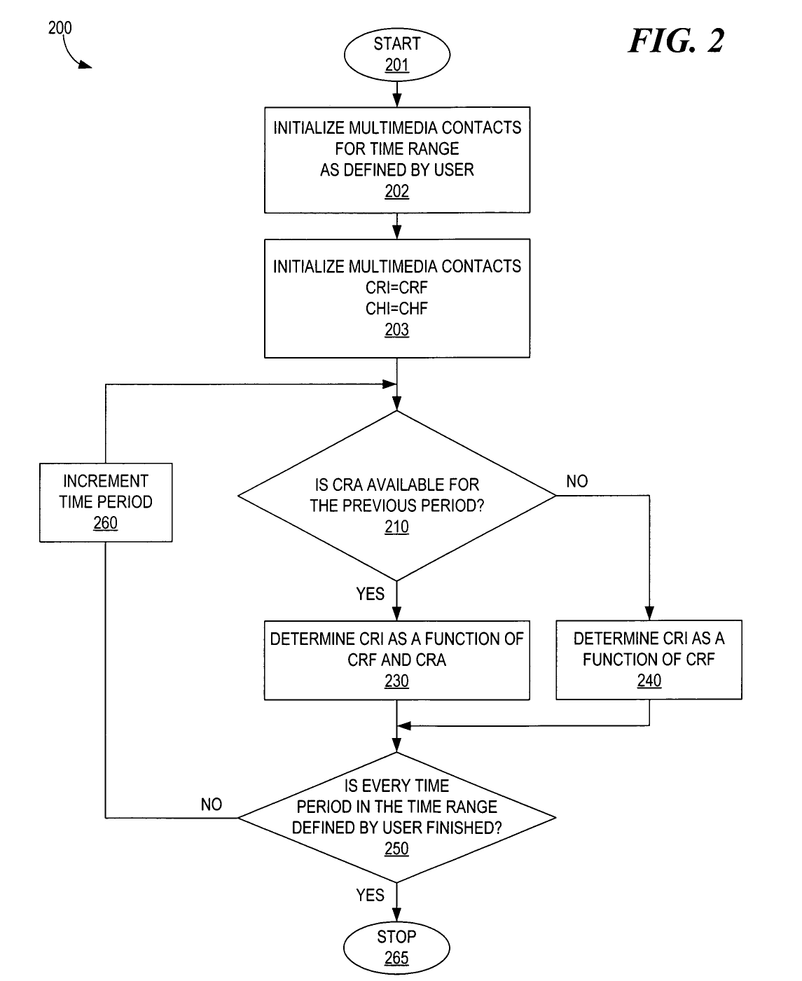

FIG. 2 illustrates a flow diagram 200. A current period can be generally defined as a period in which the system 100 makes an original prediction of the number of contacts that can be handled by agents, also known as the contacts handled forecasted, or CHF, and can have also have an associated CHI value for that time period.

After start step 201, in step 202, the system 100 initializes. Initialization occurs when the system 100 starts analyzing data going back a certain amount of time from a time period in question, such as seven days, and retrieving relevant data for the selected time period. Alternatively, it can be for the earliest possible period whose service time affects any period in the range being retrieved, or alternatively, as far back as possible if the relevant data does not exist or is otherwise unavailable. Step 202 defines a time range from a first time, which can be in the past, to a second time, which typically is in the future. In one embodiment, this end of the time range is at the end of the current day.

The relevant data can be as follows. The actual contacts received (CRA) for a given time period or periods, the contacts initially forecasted to be received for a given time period (CRF), the modified forecasted prediction of the number of contacts received (contacts received intraday, or CRI), the contacts that initially were predicted to be handled for a given time period (CHF), and the contacts that were actually handled during a given time period (CHA), if these numbers are available. Received generally refers to contacts that have been delivered to the ACD or multimedia server, and handled refers to contacts that have been completely processed by agents; for example, an e-mail may be received at 3:00 a.m. even though a contact center is not open and this e-mail is considered to be handled once an agent has responded to this e-mail, which may be later that day or even on another day.

In step 203, the number of contacts received intraday (CRI, a modified forecast of the number of contacts to be received) is set equal to the CRF for the same time period, the initial forecast, for the first time period selected by step 202. CRI is set to equal CRF for subsequent time periods. Also, a modified forecast of the number of contacts to be handled during a time period (CHI) is set equal to the number of contacts forecasted to be handled (CHF) for any time period and any or all subsequent time periods.

In step 210, the system 100 determines if the CRA value is available from a previous period from the current period. If the CRA for the previous period is not available, then the CRI, the modified prediction of how many contacts will be received by the contact center 120, is a function of at least the CRF, the original prediction or forecast of how many contacts will be received in step 240.

If the CRA for the previous period is available, then in step 230 the CRI, the modified prediction of how many contacts will be received by the contact center 120, is a function of the CRF, the original prediction or forecast of how many contacts will be received, as well as the CRA, the actual number of contacts that were received in at least one previous period, and the original CRI value for this time period can be overwritten.

In step 250, the method 200 determines whether the forecasting of intraday values CRI is complete when the last time period defined in the time range of step 202 is finished. If not, then step 260 executes, and the period to have the calculated CRI value increments. Then, step 210 is re-executed, and the CRI value for the next period is calculated in either step 230 or step 240, and so on. If the intraday forecasting is complete, stop step 265 executes, and the CRI generation is finished. One general goal of this processing is to recalculate how many contacts are expected to be received and to calculate a new plan for handling contacts for the current and future periods.

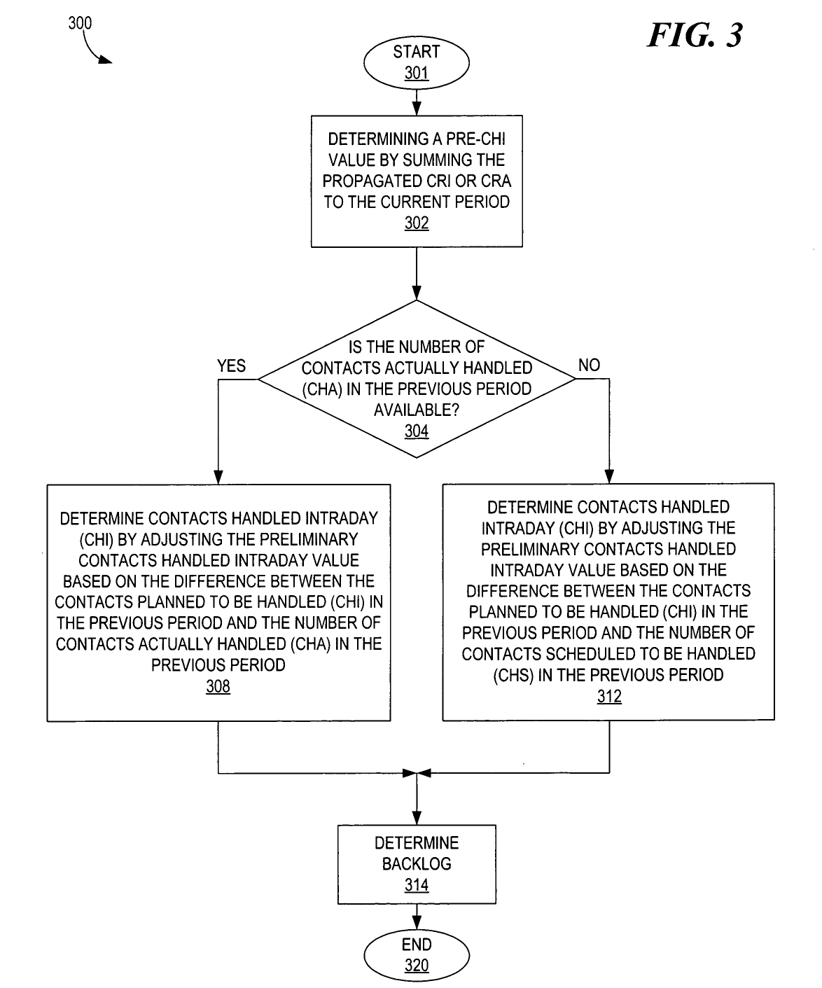

Turning now to FIG. 3, a high-level flow diagram 300 illustrates rescheduling a contacts handled intraday value to a current period. Specifically, the contacts handled intraday (CHI) value for a current period can be generally defined as the number of contacts that are planned to be handled during the current period, after a modification of that estimation is allowed to occur.

In step 302, a preliminary contacts handled intraday value (pre-CHI) for the current period is determined by propagating at least part of a contacts received value to the current period. If the CRA contact information for a time period is available, then the CRA value is propagated. If the CRA contact information is not available, then the CRI value is propagated. For instance, for a time period, say 8:00 am, the contacts handled forecast (CHF) is the result of handling contacts received from earlier periods that are scheduled to be handled during this time period. The contacts received from each of these earlier periods is then summed and yields pre-CHI, and the CHI is set equal to the pre-CHI. In other words, the pre-CHI represents the base point from which CHI recalculations use as the initial variable. A more detailed propagation scheme is described in a patent application Ser. No. 09/919,302, titled “METHOD FOR FORECASTING AND MANAGING MULTIMEDIA CONTACTS,” which patent application is assigned to the assignee of this application and is incorporated herein by reference for all purposes.

Propagation of contacts can be governed by service time or quality of service. Generally, service time is the length of time allotted to respond to a given contact. For instance, e-mails may have a 4 hour response from the time they are received, although telephone calls are generally answered within seconds or minutes of being received. These values would both affect propagation, as the telephone calls would be distributed over a narrower response time than the e-mails. Furthermore, the quality of service can differ within a contact type. For instance, e-mails from different customers or contacts could have different priorities for allotted response time. E-mails from customer “A” are to be responded to in three hours, but e-mails from “B” are to be responded to in one hour.

In step 304, it is determined whether the number of contacts actually handled (CHA) in the previous period is available. For various reasons, the number of contacts actually handled in the previous period may or may not be available. For instance, this time period could be in the future, in which case, actual data does not yet exist.

If it is determined in step 304 that the number of contacts actually handled in the previous period is available, then in step 308, the CHI value for this time period is updated by adjusting the pre-CHI value based on the difference, or carryover, between the updated number of contacts planned to be handled in a previous period (CHI) and the number of contacts actually handled in the previous period (CHA).

If it is determined in step 304 that the number of contacts actually handled in the previous period is not available, in step 312, a CHI value is updated by adjusting the pre-CHI value based on the difference between the modified number of contacts planned to be handled in a previous period (CHI) and the number of contacts scheduled to be handled in the previous period (CHS).

The number of contacts scheduled to be handled in a given period (Contacts_Handled_Scheduled or CHS) is calculated using the following equation:

$$Contacts\_Handled \_Scheduled = ( \frac{ScheduledOpen \times SecondsInStatisticsPeriod}{AHTInSeconds} )$$

where:

“ScheduledOpen” is the number of agents who are scheduled to be available in the given period;

“SecondsInStatisticsPeriod” is the length in seconds of the given period; and

“AHTInSeconds” is an average handling time in seconds for the given period.

Generally, a distinction between CHS, CHF and CHI can be stated as follows. The CHF and CHI values refer to the number of contacts that should be handled by the agents. CHF generally refers to the original forecasted number of contacts that should be handled. CHI is the updated forecast of the number of the contacts that should be handled. CHS, however, refers to the contacts which can be handled based upon the agent schedules, and considers variations in agent schedules, lunch breaks, and so on.

Generally, in either step 308 or step 312, CHI is calculated, overwriting the original CHI value derived in step 203 of method 200. Then, typically, the contact center 120 attempts to have the CHS correspond to the CHI value as closely as possible.

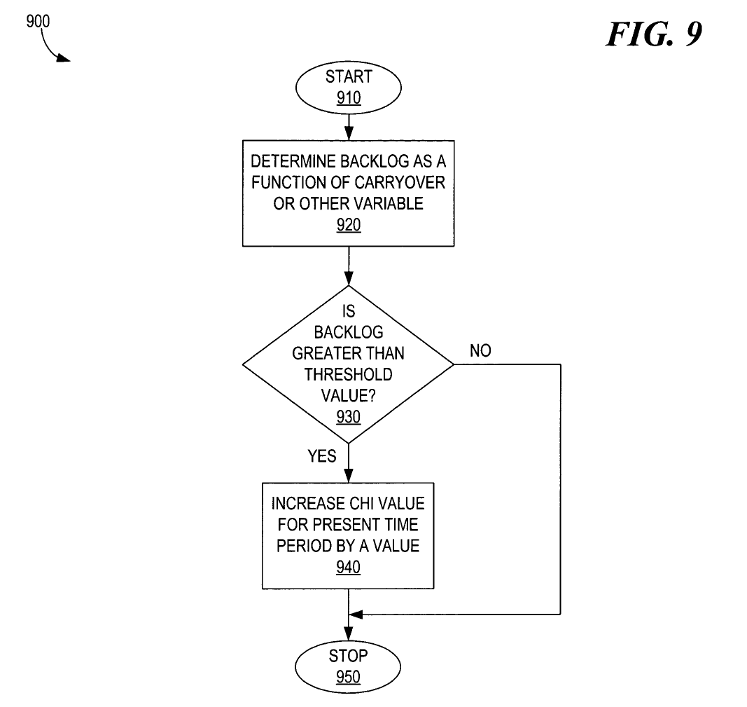

In either case, either of the steps 308 and 312 leads to step 314 in which the method 300 determines whether there is an overflow or underflow of backlogged contacts to be processed in the ACD 110, as illustrated and described in relation to method 900 of FIG. 9. If there is an overflow or underflow, then the method 300 can increase or decrease the CHI values for the current time period and future time periods, as illustrated in method 900 of FIG. 9. After the backlog processing is ended, the method 300 stops in step 320. There are various ways of defining and measuring and responding to backlog. This can either measure and respond to predicted backlog or an actual backlog. The backlog can also be measured and responded to as a function of a service time level, wherein a percentage or absolute value of the backlog has exceeded or is close to exceeding its allotted service time.

One general idea is that the revised plan for when to handle contacts will take into account periods where fewer or more contacts were actually handled than originally planned, as well as consider the number of contacts that can be handled by the staffing level.

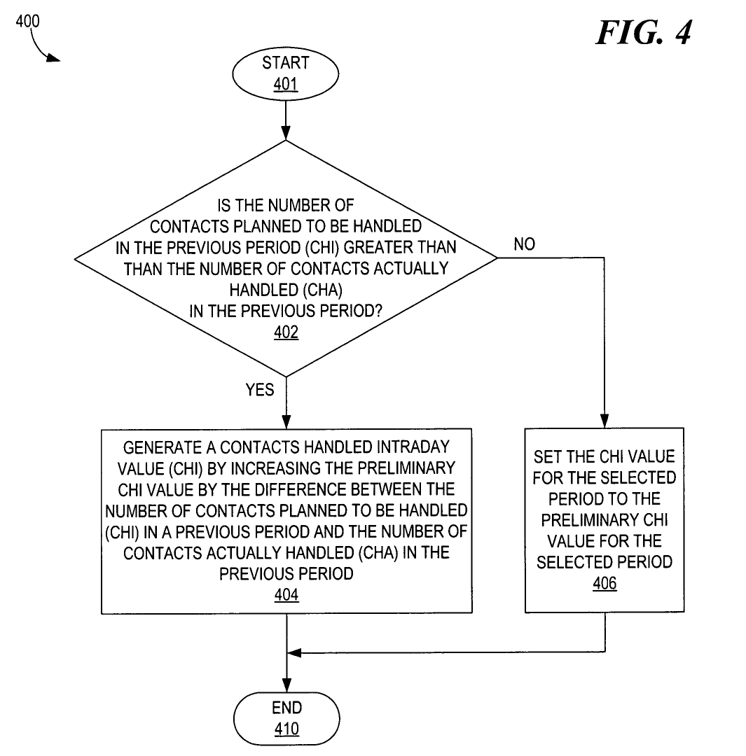

FIG. 4 is a low-level flow diagram 400 illustrating the step 308 of method 300. Step 308 relates to obtaining the contacts handled intraday (CHI) value when the number of contacts actually handled (CHA) in the previous period is available.

After a start step 401, in step 402, it is determined whether the modified forecast of the number of contacts to be handled (CHI) for the previous period is greater than the number of contacts actually handled (CHA) in the previous period. If it is determined in step 402 that the CHI of the previous period is greater than the CHA in the previous period, the adjusted CHI value for the present period in step 404 is obtained by increasing the preliminary CHI value by the difference between the number of CHI in the previous period and the CHA in the previous period. This is the output of CHI value for step 308.

However, if it is determined in step 402 that the CHI of the previous period is not greater than the CHA in the previous period, the CHI value is set to the preliminary contacts handled intraday value in step 406. This then is the output CHI value for step 308. In either event, the method ends in step 410. Generally, the contacts handled intraday (CHI) for a period is basically being adjusted to account for the difference between the contacts that were planned to be handled in a prior period and the contacts that were actually handled in that prior period.

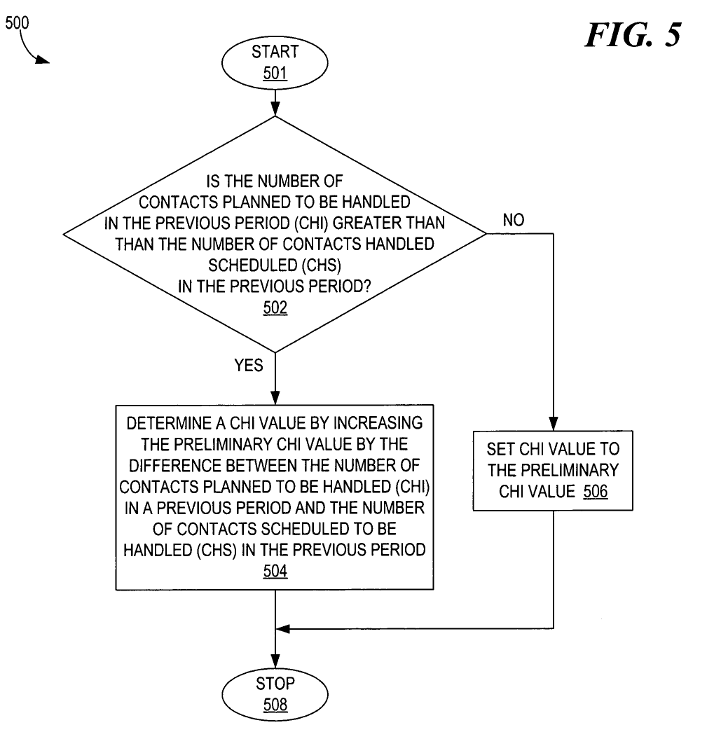

FIG. 5 is a low-level flow diagram 500 illustrating the step 312, the step of obtaining the CHI value for the present period when the CHA of the previous period is not available.

After start step 501, in step 502, it is determined whether CHI in the previous period is greater than the number of contacts scheduled to be handled in the previous period. If it is determined in step 502 that the CHI in the previous period is greater than the number of CHS in the previous period, the CHI value in step 504 of the present period is derived by increasing the preliminary CHI value by the difference between the number of CHI value a previous period and the CHS to be handled in the previous period. This is the output CHI value from step 508.

If it is determined in step 502 that the CHI in the previous period is not greater than the CHS to be handled in the previous period, the CHI value of the present period is set to the preliminary CHI value in step 506. This is the output CHI value from step 312. In either event, the method ends in step 508.

In a further embodiment, the system that manages non-immediate need contacts (for example, the WMS 126 of FIG. 1) can report actual backlog information using two values that are summed to get the actual total backlog. The first value is called an actual expired backlog and represents contacts that still need to be handled that were not handled within a service level goal time. For example, if the goal is to handle 100% of e-mails within 4 hours, and 10 e-mails have been in queue for more than 4 hours, then the actual expired backlog will be equal to 10. The other value is called an actual unexpired backlog and represents the number of contacts that still need to be handled that were in queue less than the service level goal time. For example, suppose 90 contacts are in the actual unexpired backlog. In this example, with 10 contacts in the actual expired backlog and 90 contacts in the intraday unexpired backlog, the actual total backlog is the sum or 100. Accordingly, if the e-mail (or other contact handling) system reports any 2 of these 3 values, the third value can be determined. So, if there are 100 contacts in actual total backlog and 10 are expired, then we know that 90 are unexpired.

Actual backlog values can also be used to predict backlog in the future. The backlog in the future is called intraday backlog and has three components just as the actual backlog. That is, the intraday total backlog includes two components, intraday unexpired backlog and intraday expired backlog. The intraday total backlog can be determined by calculating the intraday total backlog, the intraday unexpired backlog and then taking the difference to calculate the intraday expired backlog. If any two of the three are known the other can be calculated.

The intraday total backlog is calculated by taking the actual total backlog when calculating the intraday value for the current time period. For future time periods, the intraday total backlog is calculated by taking the intraday total backlog from the previous period and adding to that the CRF in this period and subtracting the contacts handled scheduled for this period. If the resulting number is negative, then the value used for this period's intraday total backlog is then set to zero, since for the resulting number to be negative, there is more work time to handle contacts than the work time it takes to handle contacts that are in the backlog in this period. If the intraday total backlog is zero then the intraday expired backlog and intraday unexpired backlog values are also zero.

The intraday unexpired backlog is calculated by taking the actual unexpired backlog when calculating the intraday value for the current time period. For future time periods, the intraday unexpired backlog is calculated by taking the intraday unexpired backlog from the previous period and adding the CRF value for this time period and subtracting the number of contacts that will expire this period.

Since the intraday total backlog and intraday unexpired backlog have been calculated, then the intraday expired backlog is calculated by taking intraday total backlog and subtracting the intraday unexpired backlog. Alternatively, one skilled in the art could calculate any two of the three intraday backlogs and derive the other.

In the WMS 126, it is helpful to provide management visibility into the changing conditions in the contact center throughout the day. For actual and intraday backlog values, there are a number of ways to display the data in static screens and reports as well as screens that are updated in real time as more data or data changes are made. For example, a representative system such as the WMS 126 shows backlog data on a screen in table and graphical chart formats in addition to reports. The screens are updated in real time.

Preferably, both the actual and intraday backlog data could be drilled down to show the number of contacts in the expired and unexpired backlog based on the last statistic period update from the e-mail system. In addition, a real-time feed could provide real-time statistics as to how many contacts are in the actual expired backlog and the actual unexpired backlog.

In the management of these contacts, it is helpful for the management team to have a view into the future so that problems can be anticipated or predicted and therefore avoided. The reports and/or charts of intraday backlog data can give management the information they need to prevent contacts from being handled too late. In the example of e-mails, backlogged e-mails may cause customers to call in and be handled by a phone call, thereby increasing the actual workload of the company. This most likely increases customer dissatisfaction. If the backlog gets too large, then it can be difficult to catch up; however, if the backlog gets too small, then the agents handling the contacts may not have any work to do during the slow periods of the day.

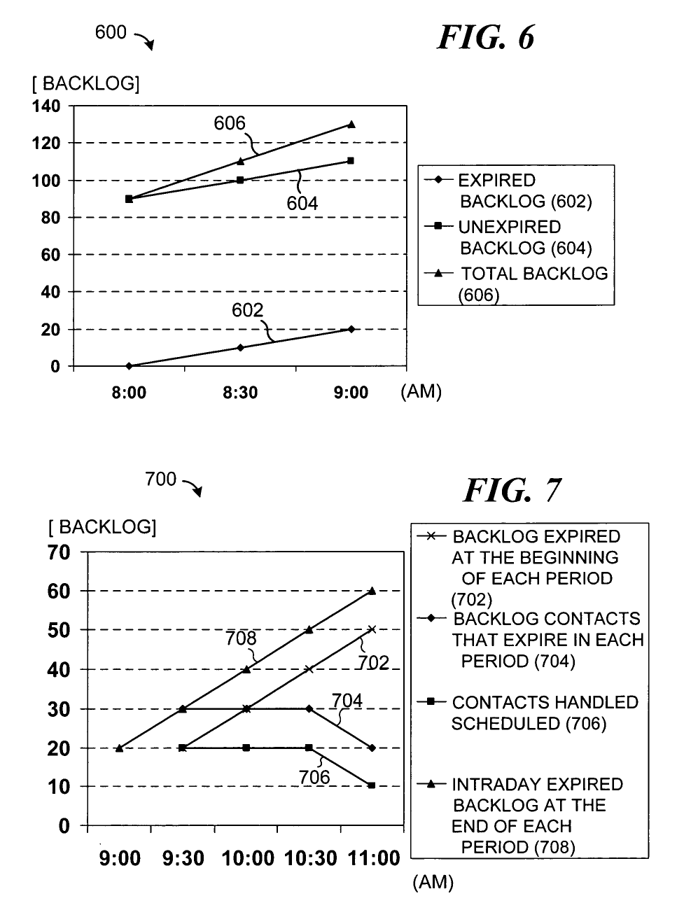

Now referring to FIG. 6, a line chart 600 illustrates actual backlog data. The line chart 600 shows actual backlog data during past periods. Specifically, the line chart 600 shows actual expired backlog data 602, actual unexpired backlog 604, and actual total backlog 606 over three periods 8:00-8:30 a.m., 8:30-9:00 a.m., and 9:00-9:30 a.m. Note that the time marks (e.g., 8:00, 8:30, and 9:00) on the x-axis indicate periods starting from the time marks and ending half an hour later.

It is important for a management team to notice that after the 8:30-9:00 period, the expired backlog 602 is greater than 0, since there are 10 contacts in the expired backlog 602, and action might be needed to catch up. For example, meetings or training time might be cancelled or overtime might be scheduled. It is clear from the line chart 600 that the contact center is getting further behind, since after the 9:00-9:30 period, the expired backlog 602 has increased to 20 from 10.

Now referring to FIG. 7, a line chart 700 illustrates an expired backlog prediction using actual and intraday expired and unexpired backlog data. The line chart 700 shows an intraday backlog expired at the beginning of each period 702, backlog contacts that expire in each period 704, contacts handled scheduled 706, and intraday expired backlog at the end of each period 708.

The line chart 700 is useful for management, because it provides an understanding of when the contacts that are in the unexpired backlog will expire. Preferably, this data could be shown to predict when contacts would move from the unexpired backlog to the expired backlog. This provides an intraday view of the expired backlog.

At 9:00 a.m., the actual unexpired backlog is 110 contacts. Preferably, another drill-down view of this unexpired backlog can be given along with contacts handled scheduled and intraday expired backlog for future periods. In the line chart 700, 110 contacts are unexpired. These are distributed as indicated by the backlog contacts that expire in each period 704-that is, 30 backlog contacts expire in each of the 9:30-10:00, 10:00-10:30, and 10:30-11:00 periods with the remaining 20 expiring in the 11:00-11:30 period. There are enough agents to handle 20 contacts in each of the 9:30-10:00, 10:00-10:30, and 10:30-11:00 periods with the ability to handle 10 contacts in the 11:00 period as shown with the contacts handled scheduled data 706. The intraday expired backlog 708 is shown and gives management time to prevent too many contacts from being handled too late by showing at 9 am that the system predicts that by 11:30 am there will be 60 contacts in the expired backlog. With this information, management may decide to cancel some meetings or schedule overtime to handle these contacts on time.

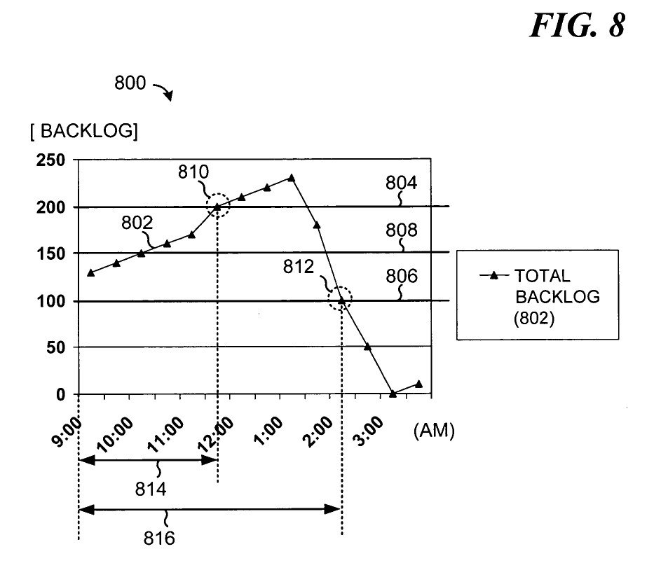

FIG. 8 is a line chart 800 illustrating a future trend of an intraday total backlog. The line chart 800 shows an intraday total backlog 802 over various time periods. The line chart provides a high threshold 804, a low threshold 806, and a target threshold 808 for backlog management. These thresholds could be static, could vary throughout the day or could be a function of contact volume, staff, intraday expired projections, any combination of these or other measures as deemed appropriate by the management team. In the line chart 800, static thresholds are assumed. These thresholds can be applied to the actual total backlog, actual expired backlog, actual expired backlog plus backlog that will expired in that period, actual unexpired backlog intraday total backlog, intraday expired backlog, intraday expired backlog plus backlog that will expired in that period, and/or intraday unexpired backlog. However, those of skill in the art will understand that other approaches for measuring and responding to backlog are within the scope of the present Application. In the line chart 800, however, only the total backlog 800 is shown.

The high threshold 804 is set to 200, the target threshold 808 is set to 150, and the low threshold 806 is set to 100. It is important for management to know when the total backlog 802 exceeds the high threshold 804 or goes lower than the low threshold 806. In the line chart 800, the total backlog 802 exceeds the high threshold 804 at a first point 810. Similarly, the total backlog 802 goes lower than the low threshold 806 at a second point 812. These are important data points to draw attention to since the time between the current time and those events gives management time to react (e.g., time durations 814 and 816) and avoid having backlog get too high or too low.

Turning now to FIG. 9, illustrated is a method 900 for altering the CHI value of the present period as a function of backlog. After start step 910, the method 900 determines the backlog of the workload as a function of the backlog in step 920. The backlog can be a function of the carryover (that is, the difference between the number of contacts that were planned to be handled and the number of contacts that were actually handled) or some other relevant variable.

In step 930, it is determined whether the backlog is greater than a threshold value. The threshold value can be a function of contact volume, staffing levels, or some other measure, or could be determined empirically by the management team. The method then stops in step 950. If it is determined that the backlog is below a set threshold, the method ends in step 950.

However, if it is determined that the backlog is greater than a threshold value, in step 940, the CHI value for the present period and, perhaps, future periods, is increased to handle the backlog. This can occur by distributing the CHI increase among a plurality of periods, or can occur to handle the backlog within a single period, is within the scope of the present application.

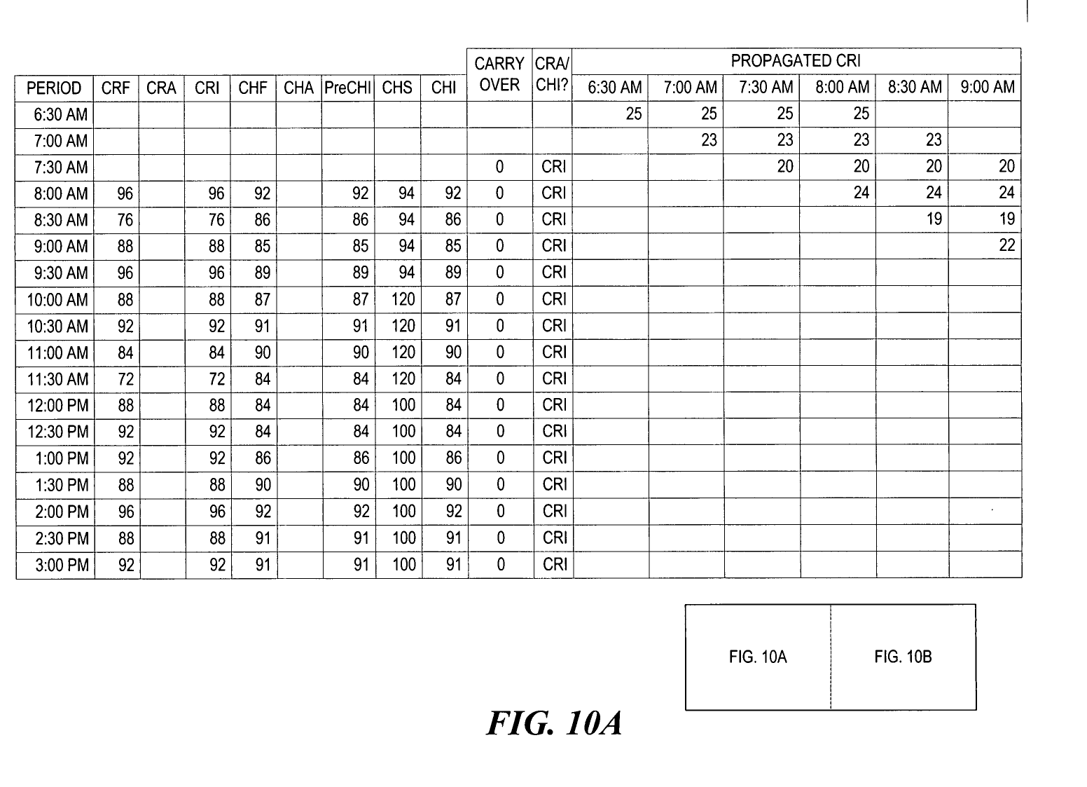

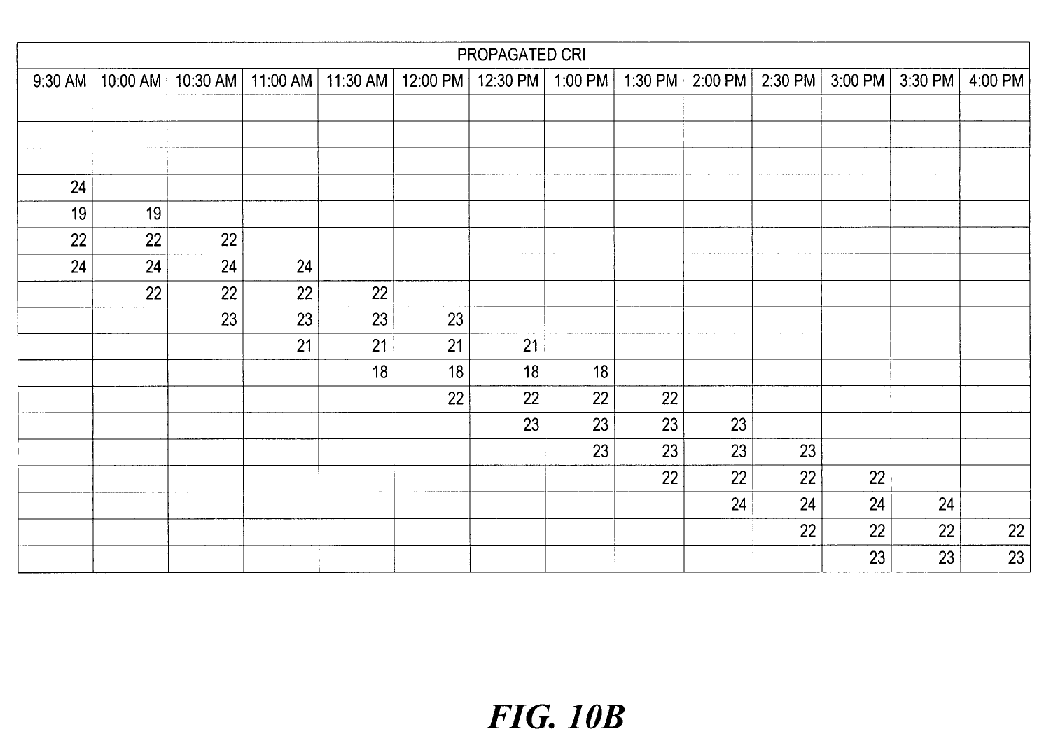

Turning now to FIGS. 10A and 10B, illustrated is a propagation of contacts from a CRF value to be distributed through different time periods before actual data has been received. An example of the use of methods 200-500 shall be illustrated with the aid of FIGS. 10A and 10B.

In FIG. 10A, the earliest time that the method concerns itself with determining CHF or CRF is 8:00 am. In FIG. 2, in step 202, the example assumes a service time of 2 hours, so the time back for the present time is 6:30 am. In other words, in 10A and 10B, 6:30 am represents the earliest period that has a CRI that has been distributed to the present time period, because contacts received during the 6:30 am time period are to be handled by 8:30 am (that is, during the 8:00 am to 8:30 am time period). In FIGS. 10A and 10B, a portion of contacts from 6:30 am, 7:00 am, 7:30 am and 8:00 am are propagated into the 8:00 am time period as the basis for determining how many contacts are planned to be handled during the 8:00 am time period.

In the system 100, typically there are always CHI values for a period, even though values in the example of FIGS. 10A and 10B are shown at 8:00 am. The initial CHI value is set to the CHF value for that first period. There will always be a CHF value for the first period.

FIGS. 10A and B are discussed in relation to 8:30. For ease of illustration, the time period of 8:30 is processed. In step 202, the CRF values, the CRI values and the CHF values are all initially calculated or obtained in step 202 of step 203. In step 203, the CRI value for 8:00 am is the same as the CRF value forecasted for 8:00 am. Furthermore, the CHI value for forecasted for 8:00 am is the same as the CHF value forecasted for 8:00 am. Thus, the CHI is set equal to the CHF as a default value for this time period.

In step 210, is a CRA value for 8:30 am available? No, there have been no actual contacts recorded. Therefore, in step 240, CRI is a determined as a function of CRF. In this case, CRI is set equal to CRF, and the CRI value is not overwritten. The setting of CRI continues until CRI values for the rest of the time periods in question, such as 8:30 a.m. through 3:00 p.m., are calculated.

After all the CRI values are calculated, then method 300 begins. In method 300, the CHI values for the time periods are calculated; the setting up of CHI to equal CHF can be overwritten for any time period other than the first time period of 8:00 am.

In step 302, the pre-CHI value is determined as illustrated in FIG. 10. In step 302, the pre-CHI of a selected period is equal to the sum of the vertical propagated CRI values for that time period. Because CRI is equal to CRF, the pre-CHI values will also be equal to the CHF values. For instance, in FIG. 10A, for 8:00 am, the propagated values are 25, 23, 20 and 24. This equals 92, the pre-CHI value.

In the method 300, CRI will be equal to CRF if there are no actual values of contacts received (CRA) for any time period being processed—for instance going back in time 7 days to get data to the selected period. Typically, there will be actual values at some period prior to the selected point, so there can be variation between the CRF and the CRA. However, even if there is not a difference between CRF and CRA, the CHS values can affect the CHI values. Therefore, method 300 is still employed, and pre-CHI is defined. In other words, in step 302, pre-CHI is still equal to the propagated CHF values for the selected period.

In step 304, is the number of contacts actually handled (CHA) available? In FIGS. 10A and B, the answer is “no”. Therefore, CHI is determined by adjusting the pre-CHI value based on the difference between the CHI for the previous period and the CHS value for the previous period. Because this is step 312, this invokes method 500, that illustrates how to calculate the difference. In method 300, if the CHS value for the previous period is greater than the CHI value for the previous period, the difference, (the “carryover”), is zero, as illustrated in FIGS. 10A and 10B. Treatment of any backlog is then determined as per method 900.

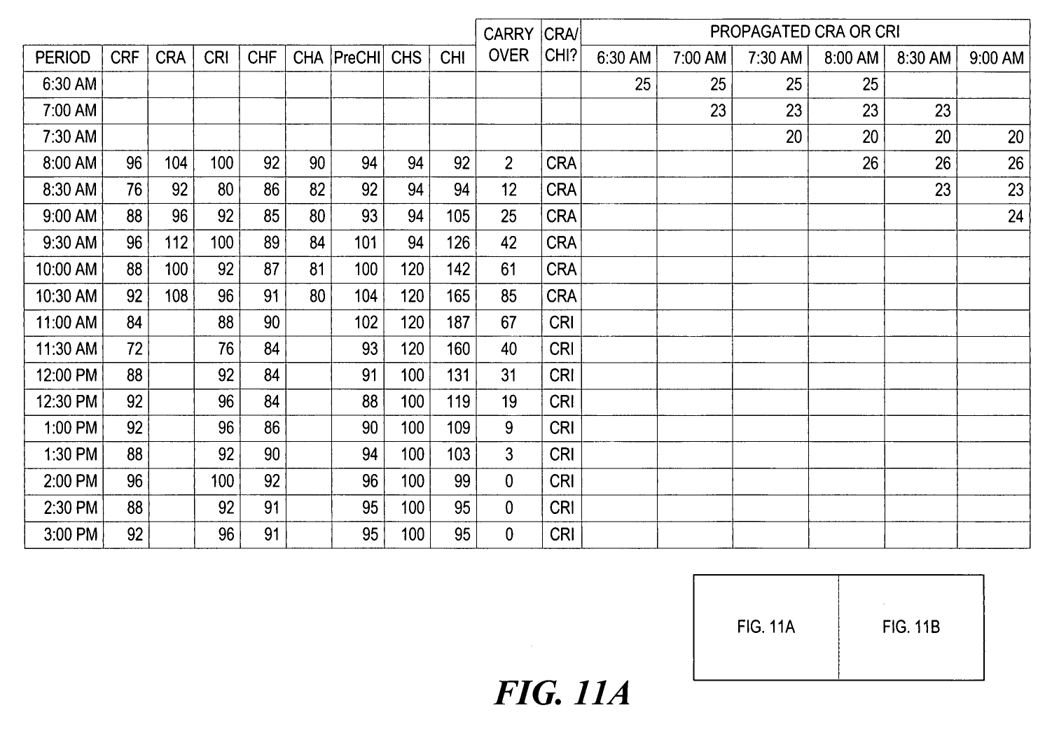

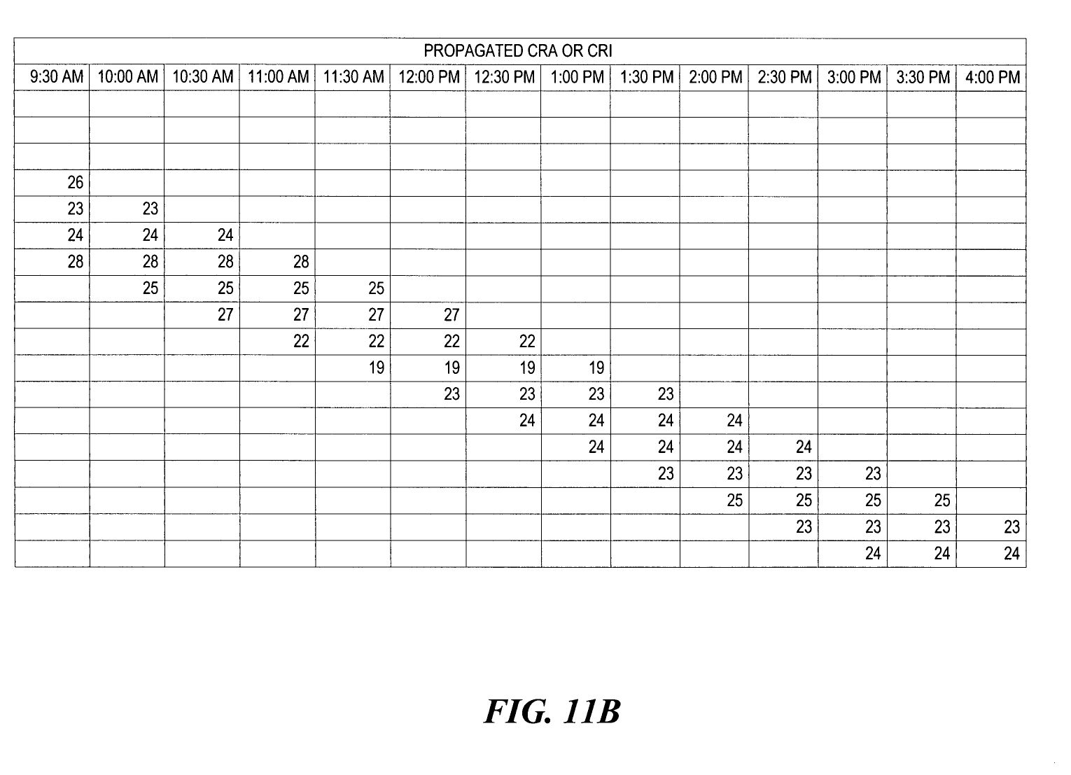

Turning now to FIGS. 11A and 11B, illustrated is a propagation of contacts after the actual contact information has been received. For instance, in FIGS. 10A and 10B, for the time period of 8:30 am, the (vertically) propagated CRI contact values are 23, 20, 24 and 19, to pre-CHI total 86. However, in FIGS. 11A and 11B for the time period of 8:30 am, the vertically propagated CRA and CRI contacts are 23, 20, 26, and 23, to yield a total of 92, a different pre-CHI value than derived in for a pre-CHI value for FIGS. 10A and 10B because CRA contacts have also been taken into account when determining the pre-CHI values. The CRF values were generated in method 200 as illustrated in FIGS. 10A and B, and are the same. However, CRA values exist up until 11:00 am in the morning in FIGS. 11A and 11B, which will affect how the CHI values are calculated for periods of 11:00 am and before.

For example, at 11:00 am, in step 210 of FIG. 2, the CRA is available for the previous period. Therefore, the CRI is determined as a function of the CRF and the CRA in step 230. However, for later time periods, there is no CRA, so the CRI is left as a function of CRF in step 240.

Then, in FIGS. 11A and 11B, the pre-CHI values are calculated, using CRA values as well as CRI values in the pre-CHI determination. In step 302, the pre-CHI values are determined by summing the vertical CRA or CRI values which terminate in the same period. For instance, at 11:30 am, the pre-CHI is 25+27+22+19=93.

In step 304, it is determined whether the number of contacts handled (CHA) in the previous period is known. For instance, for 11:00 am, the CHA value is known for 10:30, the previous period, CHI is a function of adjusting the Pre-CHI value for 11:00 am (102) by the difference between the CHI for the previous time period (165) and the CHA (80). Because step 308 was invoked and the number of contacts planned to be handled in previous period (CHI) is greater than the number of contacts actually handled, the CHI is increased by the difference. Therefore, CHI for 11:00 am is 187.

For 11:30, however, the CRA value for the previous period is not available. Therefore, CRI is the same as CRF for this period. Once Pre-CHI is calculated for this period (93), it is determined that the number of contacts in the previous period is not available in step 304. Therefore, step 312 is invoked. The CHI value for 11:30 is based on the difference between the CHI for the previous period (189) and the CHS for the previous period (120). Because this is step 312, step 500 is invoked. Because the CHI of the period is greater than the CHS of the previous period, in step 504, the CHI value uses the pre-CHI value and increases by the difference between the CHS value and the CHI value of the previous period. For 11:30 this difference between CHI (187) and CHS (120) of the previous period is 67. In FIG. 11B, 67 is added to the pre-CHI value of 93, to get a CHI value of 160.

The various acronyms used above are merely for purposes of illustration. This particular nomenclature is not intended to limit the scope of the invention.

It is understood that the present invention can take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for rescheduling workload, comprising:
selecting a period;
selecting a contacts forecasted to be received (CRF) value for the selected period;
selecting a contacts forecasted to be handled (CHF) value for the selected period;
generating a contacts handled intraday value (CHI) for the selected period as at least a function of the (CHF) value for the selected period; and
performing at least part of one or more steps above on at least one processing device.

2. The processing device of claim 1, wherein the device is an electronic device.

3. The method of claim 1, further comprising setting a contacts to be received intraday (CRI) value for the selected period equal to the CRF value for the selected period.

4. The method of claim 1, further comprising incrementing the selected period to a next period.

5. The method of claim 1, further comprising setting the CHI value to equal the CHF value for a plurality of periods.

6. The method of claim 1, further comprising determining a preliminary CHI value for the selected period.

7. The method of claim 1, further comprising summing a propagation of at least one CRA value or at least one CRI value, or both, to the selected period to obtain a preliminary CHI value.

8. The method of claim 6, further comprising determining whether a number of contacts actually handled (CHA) value in a previous period is available.

9. The method of claim 8, further comprising wherein if the CHA value of a previous period is available, updating the CHI value for the selected period as a function of the preliminary CHI value of the selected period, the CHI value for a previous period and the CHA value for the same previous period.

10. The method of claim 9, further comprising wherein if the CHI value for the previous period is greater than the CHA value for the previous period, updating the CHI value for the present period by adding a difference between the CHI value of the previous period and the CHA value of the previous period to the preliminary CHI value of the selected period.

11. The method of claim 9, wherein if the CHI value for the previous period is not greater than the CHA value for the previous period, updating the CHI value for the selected period equal to the preliminary CHI value for the selected period.

12. The method of claim 8, further comprising wherein if the CHA value of the previous period is not available, generating the CHI value for the selected period as a function of the preliminary CHI value of the selected period, the CHI value for a previous period and a contacts handled scheduled (CHS) value for the same previous period.

13. The method of claim 12, further comprising wherein if the CHI value for the previous period is greater than the CHS value for the previous period, updating the CHI value for the present period by adding the difference between the CHI value of the previous period and the CHS value of the previous period to the preliminary CHI value of the selected period.

14. The method of claim 12, further comprising wherein if the CHI value for the previous period is not greater than the CHS for the previous period, updating the CHI value for the present period equal to the preliminary CHI value for the selected period.

15. A method for processing a backlog in a contact center environment, comprising:
determining whether a backlog value exceeds a threshold value; and
updating a contacts handled intraday (CHI) value for at least one time period as a function of the backlog value.

16. The method of claim 15, wherein the step of updating the CHI value is performed as a function of a threshold value.

17. The method of claim 15, wherein the backlog is an actual total backlog value.

18. The method of claim 17, further comprising calculating the actual backlog value as a sum of an expired backlog value and an unexpired backlog value.

19. The method of claim 15, wherein the backlog is an intraday expired backlog value.

20. The method of claim 17, further comprising calculating the intraday expired backlog value as a difference between an expired total backlog value and an intraday unexpired backlog value.

21. The method of claim 16, further comprising updating the CHI value for a plurality of periods.

22. A system for calculating a contacts handled intraday value, comprising:
a server for providing contacts data;
a management system coupled to the server, wherein the management system is configured to generate and update a contact handled intraday (CHI) value for at least one time period.

23. The system of claim 22, further comprising a database coupled to the management system, wherein the database is configured to store contacts.

24. The system of claim 22, wherein the contact comprises at least one e-mail message.

25. The system of claim 22, wherein the contact comprises at least one telephone message.

26. A computer program product for rescheduling workload, the computer program product having a medium with a computer program embodied thereon, the computer program comprising:
code for selecting a period;
code for selecting a contacts forecasted to be received (CRF) value for the selected period;
code for selecting a contacts forecasted to be handled (CHF) value for the selected period;
code for generating a contacts handled intraday value (CHI) for the selected period as a function of the (CHF) value for the selected period; and
code for updating the CHI value.

27. A processor for rescheduling workload, the processor including a computer program comprising:
code for selecting a period;
code for selecting a contacts forecasted to be received (CRF) value for the selected period;
code for selecting a contacts forecasted to be handled (CHF) value for the selected period;
code for generating a contacts handled intraday value (CHI) for the selected period equal to the (CHF) value for the selected period; and
code for updating the CHI value.
